(19) United States
(12) Patent Application Publication
(10) Pub. No.: US 2025/0153491 A1
(43) Pub. Date: May 15, 2025

(54) PRINTING MEDIUM PLACEMENT METHOD AND DOUBLE-SIDED ADSORPTIVE SHEET

(71) Applicant: SEIKO EPSON CORPORATION, Tokyo (JP)

(72) Inventor: Satoru MIYAMOTO, MATSUMOTO-SHI (JP)

(21) Appl. No.: 18/943,192

(22) Filed: Nov. 11, 2024

(30) Foreign Application Priority Data
Nov. 13, 2023 (JP) 2023-192820

(51) Int. Cl. B41J 11/06; B41J 11/14

(52) U.S. Cl. CPC B41J 11/06; B41J 11/14

(57) ABSTRACT

A printing medium placement method that includes a preparation step of attaching a first surface of a double-sided adsorptive sheet to a flat placement surface of a platen on which a sheet-like printing medium is placeable, and a printing medium placement step of attaching the printing medium to a second surface opposite to the first surface of the double-sided adsorptive sheet attached in the preparation step, wherein the double-sided adsorptive sheet includes an adsorptive layer at each of the first surface and the second surface, and adsorption force of the first surface for the placement surface is stronger than adsorption force of the second surface for the printing medium.

The present application is based on, and claims priority from JP Application Serial Number 2023-192820, filed Nov. 13, 2023, the disclosure of which is hereby incorporated by reference herein in its entirety.

### BACKGROUND

### 1. Technical Field

The present disclosure relates to a printing medium placement method and a double-sided adsorptive sheet.

### 2. Related Art

In the related art, printing apparatuses of various configurations have been used. Among such printing apparatuses, there is a printing apparatus in which a printing medium is placed on a platen as a placement portion and the printing medium is fixed so as not to move on the platen. For example, JP 2018-138361 A discloses a printing apparatus in which a friction member is disposed at a tray as a platen so that a printing medium does not move from a support surface of the tray.

In recent years, various types of printing media have been used, but for example, a film is used as a sheet-like printing medium in some cases. The film is slippery, and it may be difficult to fix the printing medium so as not to move on the platen even when a friction member is placed on the platen. Note that although it is conceivable to fix the sheet-like printing medium on the platen using an adhesive tape or the like, it requires time and effort to attach the adhesive tape on the platen. Further, a part of the sheet-like printing medium attached by the adhesive tape is likely to be in a floating state, and in such a state, a printing failure is likely to occur, therefore, it is often necessary to place the sheet-like printing medium again. When the sheet-like printing medium is fixed on the platen using an adhesive tape or the like, it also requires time and effort to place the sheet-like printing medium again. Therefore, when the sheet-like printing medium is used, it is not convenient to place the sheet-like printing medium on the platen.

### SUMMARY

A printing medium placement method of the present disclosure for solving the above-described problems includes a preparation step for attaching a first surface of a double-sided adsorptive sheet to a flat placement surface of a platen on which a sheet-like printing medium is placeable, and a printing medium placement step for attaching the printing medium to a second surface opposite to the first surface of the double-sided adsorptive sheet attached in the preparation step, wherein the double-sided adsorptive sheet includes an adsorptive layer at each of the first surface and the second surface, and adsorption force of the first surface for the placement surface is stronger than adsorption force of the second surface for the printing medium.

Additionally, a double-sided adsorptive sheet of the present disclosure for solving the above-described problems is a double-sided adsorptive sheet used in such a way that a first surface is attached to a flat placement surface of a platen on which a sheet-like printing medium is placeable and the printing medium is attached to a second surface opposite to the first surface, the double-sided adsorptive sheet including an adsorptive layer at each of the first surface and the second surface, wherein adsorption force of the first surface for the placement surface is stronger than adsorption force of the second surface for the printing medium.

### BRIEF DESCRIPTION OF THE DRAWINGS

FIG. 1 is a schematic perspective view illustrating a printing apparatus capable of performing a printing medium placement method of the present disclosure.

FIG. 2 is a perspective view illustrating a state in which a double-sided adsorptive sheet is attached to a platen of the printing apparatus in FIG. 1 and a film is placed at the double-sided adsorptive sheet.

FIG. 3 is a side view illustrating a state in which the double-sided adsorptive sheet is attached to the platen of the printing apparatus in FIG. 1 and the film is placed at the double-sided adsorptive sheet.

FIG. 4 is a side view illustrating a state in which the double-sided adsorptive sheet is attached to the platen of the printing apparatus in FIG. 1.

FIG. 5 is a side view illustrating the platen of the printing apparatus in FIG. 1.

FIG. 6 is a flowchart illustrating an example of a printing medium placement method of the present disclosure performed using the printing apparatus in FIG. 1.

FIG. 7 is a plan view illustrating a state in which the double-sided adsorptive sheet is attached to the platen of the printing apparatus in FIG. 1 in an aspect different from FIGS. 2 and 3.

### DESCRIPTION OF EMBODIMENTS

First, an overview of the present disclosure will be described.

A printing medium placement method of a first aspect of the present disclosure for solving the above-described problems includes a preparation step for attaching a first surface of a double-sided adsorptive sheet to a flat placement surface of a platen on which a sheet-like printing medium is placeable, and a printing medium placement step for attaching the printing medium to a second surface opposite to the first surface of the double-sided adsorptive sheet attached in the preparation step, wherein the double-sided adsorptive sheet includes an adsorptive layer at each of the first surface and the second surface, and adsorption force of the first surface for the placement surface is stronger than adsorption force of the second surface for the printing medium.

According to the present aspect, it is possible to easily perform preparation for placing the printing medium at the platen by using the double-sided adsorptive sheet which is used in such a way that the first surface is attached to the placement surface of the platen and the printing medium is attached to the second surface. In addition, since the adsorption force of the first surface for the placement surface is stronger than the adsorption force of the second surface for the printing medium, it is easy to place the printing medium again. Accordingly, convenience when the printing medium is placed at the platen can be improved.

The printing medium placement method of a second aspect of the present disclosure is an aspect dependent on the first aspect, wherein the platen is mounted at a printing apparatus so as to reciprocate in a direction parallel to the placement surface, and F2>m×a is satisfied, where F2 is adsorption force of the second surface, m is a mass of the printing medium, and a is a maximum acceleration while the platen moves.

According to the present aspect, F2>m×a is satisfied, where F2 is the adsorption force of the second surface, m is the mass of the printing medium, and a is the maximum acceleration while the platen moves. When such a relationship is satisfied, it is possible to prevent the printing medium from being peeled off from the platen in accordance with the movement of the platen.

The printing medium placement method of a third aspect of the present disclosure is an aspect dependent on the second aspect, wherein F1>(m+ms)×a is satisfied, where F1 is adsorption force of the first surface and ms is a mass of the double-sided adsorptive sheet.

According to the present aspect, F1>(m+ms)×a is satisfied, where F1 is the adsorption force of the first surface and ms is the mass of the double-sided adsorptive sheet. When such a relationship is satisfied, it is possible to prevent the double-sided adsorptive sheet from being peeled off from the platen in accordance with the movement of the platen.

The printing medium placement method of a fourth aspect of the present disclosure is an aspect dependent on any one of the first to third aspects, wherein F1p>F2p is satisfied, where F1p is a force required to peel off the first surface from the placement surface, and F2p is a force required to peel off the printing medium from the second surface, with respect to a direction intersecting the placement surface.

According to the present aspect, when the force required to peel off the first surface from the placement surface is F1p and the force required to peel off the printing medium from the second surface is F2p, with respect to a direction intersecting the placement surface, F1p>F2p is satisfied. When such a relationship is satisfied, it is possible to prevent the double-sided adsorptive sheet from being peeled off from the platen together with the printing medium in accordance with removal of the printing medium from the platen.

The printing medium placement method of a fifth aspect of the present disclosure is an aspect dependent on any one of the first to third aspects, wherein the first surface has a self-adsorption property.

According to the present aspect, the first surface has a self-adsorption property. Therefore, it is possible to improve convenience when the double-sided adsorptive sheet is attached to the placement surface.

The printing medium placement method of a sixth aspect of the present disclosure is an aspect dependent on any one of the first to third aspects, wherein the second surface has a self-adsorption property.

According to the present aspect, the second surface has a self-adsorption property. Therefore, it is possible to improve convenience when the printing medium is attached to the double-sided adsorptive sheet.

The printing medium placement method of a seventh aspect of the present disclosure is an aspect depending on any one of the first to third aspects, wherein in the printing medium placement step, the printing medium is attached to the second surface so that a part of the printing medium does not come into contact with the second surface.

According to the present aspect, in the printing medium placement step, the printing medium is attached to the second surface so that a part of the printing medium does not come into contact with the second surface. Therefore, when removing the printing medium from the platen, an operator can remove the printing medium from the platen while holding the part that does not come into contact with the second surface, and convenience can be improved.

The printing medium placement method of an eighth aspect of the present disclosure is an aspect dependent on any one of the first to third aspects, and includes a printing step for performing printing on the printing medium after the printing medium placement step is performed, wherein the printing medium placement step is performed again with a pre-print printing medium for newly performing the printing step after a post-print printing medium is removed after the printing step is performed.

According to the present aspect, the printing medium placement step is performed again with the pre-print printing medium for newly performing the printing step after the post-print printing medium is removed after the printing step is performed. For this reason, it is possible to suitably and repeatedly perform the printing step for a plurality of the printing media.

The printing medium placement method of a ninth aspect of the present disclosure is an aspect dependent on any one of the first to third aspects, wherein the first surface and the second surface are formed to be distinguishable.

According to the present aspect, the first surface and the second surface are formed to be distinguishable from each other. Therefore, it is possible to prevent the double-sided adsorptive sheet from being placed on the platen with the first surface and the second surface being mistaken.

The printing medium placement method of a tenth aspect of the present disclosure is an aspect dependent on the ninth aspect, wherein at least one of the first surface and the second surface includes an identification mark.

According to the present aspect, at least one of the first surface and the second surface includes the identification mark. Therefore, the first surface and the second surface can be easily distinguished from each other by the identification mark, and it is possible to easily prevent the double-sided adsorptive sheet from being placed on the platen with the first surface and the second surface being mistaken.

A double-sided adsorptive sheet of an eleventh aspect of the present disclosure is a double-sided adsorptive sheet used in such a way that a first surface is attached to a flat placement surface of a platen on which a sheet-like printing medium is placeable and the printing medium is attached to a second surface opposite to the first surface, the double-sided adsorptive sheet including an adsorptive layer at each of the first surface and the second surface, wherein adsorption force of the first surface for the placement surface is stronger than adsorption force of the second surface for the printing medium.

According to the present aspect, it is possible to easily perform preparation for placing the printing medium at the platen by using the double-sided adsorptive sheet which is used in such a way that the first surface is attached to the placement surface of the platen and the printing medium is attached to the second surface. In addition, since the adsorption force of the first surface for the placement surface is stronger than the adsorption force of the second surface for the printing medium, it is easy to place the printing medium again. Accordingly, convenience when the printing medium is placed at the platen can be improved.

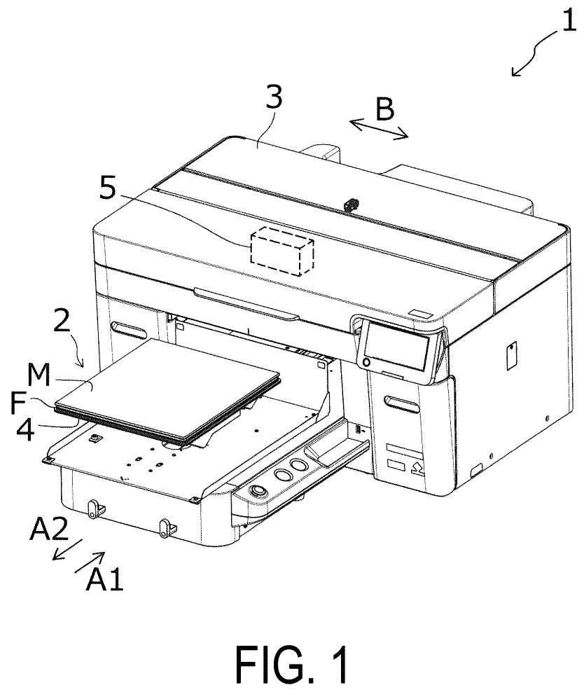

Below, the printing medium placement method and the double-sided adsorptive sheet of the present disclosure will be described with reference to the accompanying drawings. First, an outline of a printing apparatus 1 according to an example for which the printing medium placement method of the present disclosure can be performed and the double-sided adsorptive sheet of the present disclosure can be used will be described mainly with reference to FIG. 1. FIG. 1 is a schematic perspective view of the printing apparatus 1 according to the present example.

As illustrated in FIG. 1, the printing apparatus 1 of the present example includes a medium transport unit 2 that includes a platen 4 on which a sheet-like printing medium M is placeable. The medium transport unit 2 is configured to be capable of moving the platen 4 in a direction A1 and a direction A2. A main body portion 3 of the printing apparatus 1 is provided with a printing unit 5 capable of reciprocating in a scanning direction B intersecting the direction A1 and the direction A2.

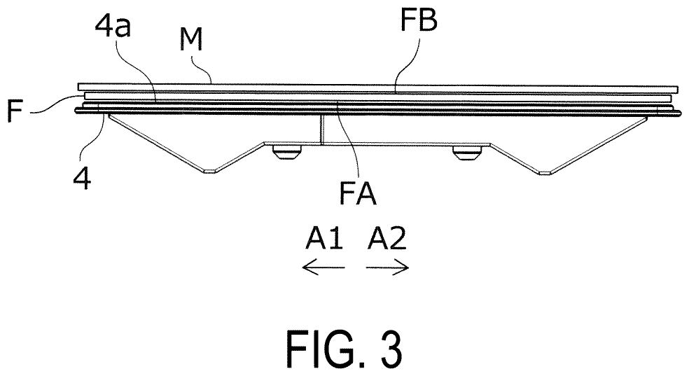

The printing apparatus 1 of the present example is configured to be capable of performing printing by moving the platen 4 in the direction A1 from a state in which the platen 4 at which the printing medium M is placed is placed at a position illustrated in FIG. 1, and then ejecting ink from the printing unit 5 while moving the platen 4 in the direction A2. In the printing apparatus 1 of the present example, a film formed of resin may be used as the printing medium M. Since the film easily slips with respect to a placement surface 4a of the platen 4 illustrated in FIGS. 3 to 5, the placement surface 4a may be provided with a member with which the film is unlikely to slip and can be held. Therefore, in FIG. 1, a double-sided adsorptive sheet F is disposed at the placement surface 4a as a member with which the film is unlikely to slip and can be held.

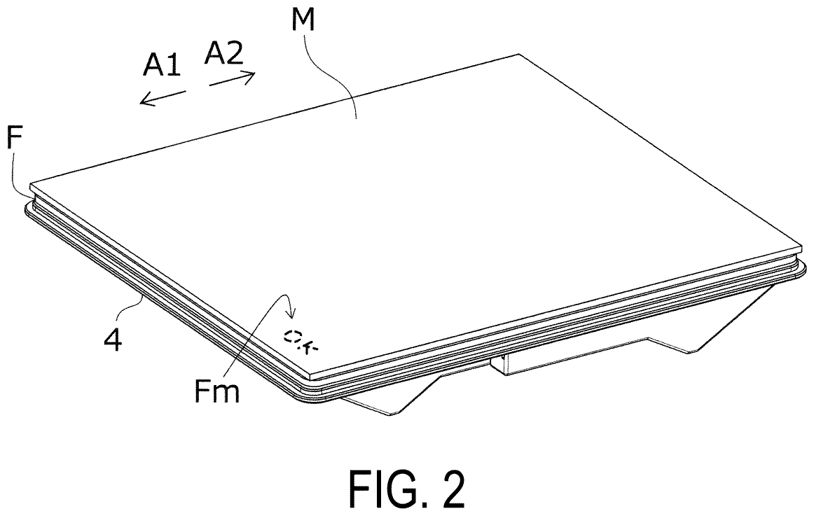

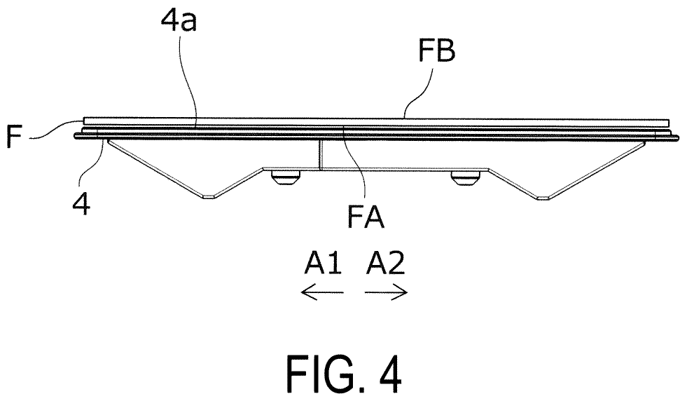

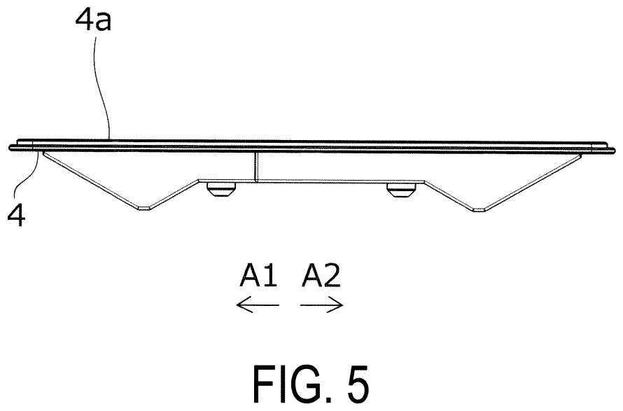

Hereinafter, the printing medium placement method that can be performed using the printing apparatus 1 of the present example and the double-sided adsorptive sheet F that can be used for the printing apparatus 1 of the present example will be described with reference to FIGS. 2 to 7. First, description will be made from the viewpoint of the double-sided adsorptive sheet F. The double-sided adsorptive sheet F that can be used for the printing apparatus 1 of the present example is a double-sided adsorptive sheet that is used in such a way that a first surface FA as illustrated in FIG. 4 is attached to the flat placement surface 4a of the platen 4 on which the sheet-like printing medium M as illustrated in FIG. 5 is placeable and additionally the printing medium M is attached to a second surface FB opposite to the first surface FA as illustrated in FIG. 3.

The double-sided adsorptive sheet F includes an adsorptive layer at each of the first surface FA and the second surface FB. Here, adsorption force of the first surface FA for the placement surface 4a is configured to be stronger than adsorption force of the second surface FB for the printing medium M. By using such a double-sided adsorptive sheet F which is used in such a way that the first surface FA is attached to the placement surface 4a of the platen 4 and the printing medium M is attached to the second surface FB, it is possible to easily perform preparation for placing the printing medium M at the platen 4. This is because even when the printing medium M is placed at the placement surface 4a in a bent state, the printing medium M can be easily placed again for any number of times. In addition, since the adsorption force of the first surface FA for the placement surface 4a is stronger than the adsorption force of the second surface FB for the printing medium M, it is particularly easy to place the printing medium M again. This is because it is possible to prevent the double-sided adsorptive sheet F from being peeled off from the platen 4 by the double-sided adsorptive sheet F being attached to the printing medium M, when the printing medium M is placed again. Therefore, by using such a double-sided adsorptive sheet F, it is possible to improve convenience when the printing medium M is placed at the platen 4. In addition, when the double-sided adsorptive sheet F is deteriorated such as stained, it is possible to replace the double-sided adsorptive sheet F itself by peeling off the first surface FA from the placement surface 4a.

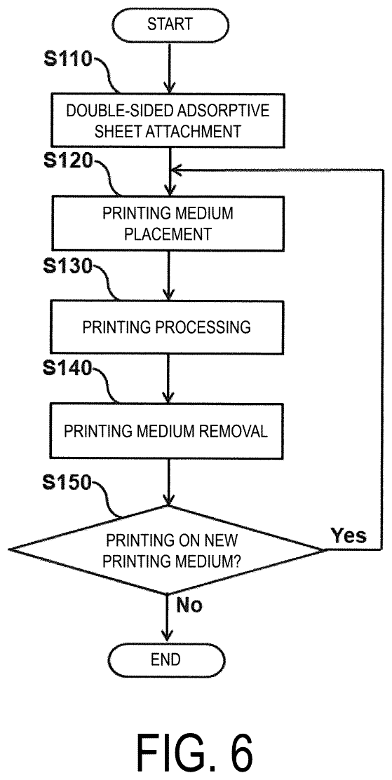

Next, description will be given from the viewpoint of the printing medium placement method using the printing apparatus 1 of the present example. In the printing medium placement method of the present example, as illustrated in a flowchart of FIG. 6, first, in step S110, the double-sided adsorptive sheet F is attached to the placement surface 4a of the platen 4 so that a state illustrated in FIG. 5 transitions to a state illustrated in FIG. 4. More specifically, step S110 corresponds to a preparation step for attaching the first surface FA of the double-sided adsorptive sheet F to the flat placement surface 4a of the platen 4 on which the sheet-like printing medium M is placeable.

Next, in a printing medium placement step in step S120, the printing medium M is attached to the second surface FB opposite to the first surface FA of the double-sided adsorptive sheet F attached to the placement surface 4a in the preparation step in step S110 so that a state illustrated in FIGS. 2 and 3 is reached. As described above, the double-sided adsorptive sheet F includes the adsorptive layer at each of the first surface FA and the second surface FB, and the adsorption force of the first surface FA for the placement surface 4a is stronger than the adsorption force of the second surface FB for the printing medium M. As described above, by using the double-sided adsorptive sheet F which is used in such a way that the first surface FA is attached to the placement surface 4a of the platen 4 and the printing medium M is attached to the second surface FB, it is possible to easily perform preparation for placing the printing medium M at the platen 4. In addition, since the adsorption force of the first surface FA for the placement surface 4a is stronger than the adsorption force of the second surface FB for the printing medium M, it is easy to place the printing medium M again. Therefore, by performing the printing medium placement method of the present example, it is possible to improve convenience when the printing medium M is placed at the platen 4.

Next, after the printing medium placement step in step S120 is performed, in a printing step in step S130, ink is ejected from the printing unit 5 onto the printing medium M transported by the medium transport unit 2 to perform printing on the printing medium M. Then, in a printing medium removal step in step S140, the printing medium M subjected to the printing in the printing step in step S130 is removed from the platen 4. Then, in step S150, it is determined whether printing is to be performed on a new printing medium M or not, and when it is determined to perform printing on the new printing medium M, the method returns to the printing medium placement step in step S120, and when it is determined not to perform printing on the new printing medium M, the printing medium placement method according to the present example ends.

That is, the printing medium placement step in step S120 is performed again with a pre-print printing medium for newly performing the printing step in step S130 after a post-print printing medium is removed after the printing step in step S130 is performed. The post-print printing medium is the printing medium M subjected to the printing by performing the printing step in step S130, and the pre-print printing medium is the printing medium M before the printing step is performed in step S130 for newly performing printing. By adopting such a printing medium placement method, it is possible to suitably perform the printing step in step S130 repeatedly for a plurality of the printing media M.

In the double-sided adsorptive sheet F used in such a printing medium placement method, the first surface FA and the second surface FB may be formed to be distinguishable from each other. This is because it is possible to prevent the double-sided adsorptive sheet F from being placed at the platen 4 with the first surface FA and the second surface FB being mistaken, since the first surface FA and the second surface FB are formed so as to be distinguishable from each other.

Examples in which the first surface FA and the second surface FB are formed to be distinguishable from each other include, a case where an identification mark Fm is provided at at least one of the first surface FA and the second surface FB. FIG. 2 illustrates a state in which the identification mark Fm formed at the second surface FB of the double-sided adsorptive sheet F can be recognized through the printing medium M which is a transparent film. In the double-sided adsorptive sheet F of the present example, the identification mark Fm written as “OK” is formed at the second surface FB of the double-sided adsorptive sheet F. When the identification mark Fm is viewed from the second surface FB side, the characters “OK” can be recognized, however, when the identification mark Fm is viewed from the first surface FA side, the characters “OK” have an inverted shape and are not correct characters. Therefore, the characters “OK” can be recognized when the first surface FA of the double-sided adsorptive sheet F is attached to the placement surface 4a. Therefore, since the identification mark Fm is provided at the double-sided adsorptive sheet F, the first surface FA and the second surface FB can be easily distinguished from each other by the identification mark Fm, and it is possible to easily prevent the printing medium M from being placed at the platen 4 with the first surface FA and the second surface FB being mistaken. Note that it is sufficient that the identification mark Fm can be recognized as correct characters when viewed from the second surface FB side, and the identification mark Fm may be formed at the first surface FA as long as the identification mark Fm can be visually recognized through the double-sided adsorptive sheet F. In addition, as long as it is possible to recognize whether the orientation is correct or reversed, a symbol, a pattern, or the like other than characters may be used as the identification mark Fm.

The platen 4 is mounted at the printing apparatus 1 of the present example so as to reciprocate in the direction A1 and the direction A2 which are directions parallel to the placement surface 4a. Here, in the printing apparatus 1 of the present example, F2>m×a is satisfied, where F2 is the adsorption force of the second surface FB for the printing medium M, m is a mass of the printing medium M, and a is the maximum acceleration while the platen 4 reciprocates in the direction A1 and the direction A2. When such a relationship is satisfied, it is possible to prevent the printing medium M from being peeled off from the platen 4 in accordance with the movement of the platen 4.

The adsorption force can be ensured by using, for example, a silicone adhesive composition or the like for the adsorptive layers of the double-sided adsorptive sheet F. For example, a suitable adsorptive layer can be obtained by applying a silicone adhesive composition or the like to the first surface FA and the second surface FB and curing the composition under predetermined conditions. The adsorption force can be measured by, for example, a method for measuring 180° peeling adhesive force specified in JIS Z 0237. When a silicone adhesive composition or the like is used for the adsorptive layers of the double-sided adsorptive sheet F, adjustment of the adsorption force can be achieved by, for example, adjusting an alkenyl group. On the other hand, when another adhesive composition or the like is used for the adsorptive layers of the double-sided adsorptive sheet F, the adjustment can be achieved by selecting types of components other than a base polymer in an adhesive for obtaining the adsorptive layers, adjusting blending amounts of the components, and the like. Examples of the components include a crosslinking agent, a silane coupling agent, and an oligomer.

Examples of the double-sided adsorptive sheet F and the printing medium M include plastic film substrates made of polyester, poly (meth) acrylate, polycarbonate, polyethylene, polypropylene, polystyrene, polyamide, polyimide, polyphenylene sulfide, polytetrafluoroethylene, polyvinyl chloride, polyurethane, triacetylcellulose, polyacetal, a norbornene-based resin (“ARTON” (trade name) manufactured by JSR Corporation), a cycloolefin-based resin (“ZEONOR” (trade name) manufactured by Zeon Corporation), an epoxy resin, a phenol resin, and the like, and composite substrates obtained by laminating a plurality of these substrates. In addition, polyester films such as polyethylene terephthalate, polybutylene terephthalate and polyethylene naphthalate, polyimide films, polyacrylate films such as polyacrylate and polymethacrylate, and polycarbonate films may be used. On the other hand, various acrylic resins may be used as the platen 4.

In addition, in the printing apparatus 1 of the present example, F1>(m+ms)×a is satisfied, where the adsorption force of the first surface FA is F1 and the mass of the double-sided adsorptive sheet F is ms. When such a relationship is satisfied, it is possible to prevent the double-sided adsorptive sheet F from being peeled off from the platen 4 in accordance with the movement of the platen 4.

In addition, in the printing apparatus 1 of the present example, F1p>F2p is satisfied, where the force required to peel off the first surface FA from the placement surface 4a is F1p, and the force required to peel off the printing medium M from the second surface FB is F2p with respect to a vertical direction which is a direction intersecting the placement surface 4a. When such a relationship is satisfied, it is possible to prevent the double-sided adsorptive sheet F from being peeled off from the platen 4 together with the printing medium M in accordance with removal of the printing medium M from the platen 4.

Note that a protective film for protecting a screen of a smartphone or a tablet is generally used. As for the double-sided adsorptive sheet F, a technology for an adsorptive layer used for such a protective film can be diverted.

Here, the first surface FA of the double-sided adsorptive sheet F of the present example has a self-adsorption property. Since the first surface FA of the double-sided adsorptive sheet F has a self-adsorption property as described above, it is possible to improve convenience when the double-sided adsorptive sheet F is attached to the placement surface 4a.

Further, the second surface FB of the double-sided adsorptive sheet F of the present example also has a self-adsorption property. Since the second surface FB of the double-sided adsorptive sheet F has a self-adsorption property as described above, it is possible to improve convenience when the printing medium M is attached to the double-sided adsorptive sheet F.

The adsorptive layer having a self-adsorption property is a layer having low adhesive force thus is easily peeled off from a member at the time of peeling and quickly fits to the member at the time of attachment. In other words, the layer is a layer, when pressure-bonded to a smooth surface, that can be adhesive by self-adsorption force without an adhesive agent or a gluing agent, and can be easily peeled off as necessary. By using the adsorptive layer having a self-adsorption property, it is possible to suppress mixing of air bubbles, and even when air bubbles are mixed, the air bubbles can be eliminated with time.

At least one of the first surface FA and the second surface FB of the double-sided adsorptive sheet F may be subjected to antistatic treatment. As the antistatic treatment, it is possible to perform a treatment with an antistatic agent such as a surfactant-based, silicone-based, organic boron-based, conductive polymer-based, metal oxide-based, or vapor-deposited metal-based antistatic agent.

In addition, in the printing medium placement step in step S120 described above, the printing medium M may be attached to the second surface FB so that a part of the printing medium M does not come into contact with the second surface FB. For example, as illustrated in FIG. 2, by chamfering or rounding at least one of four corner portions of the substantially rectangular double-sided adsorptive sheet F, or making the double-sided adsorptive sheet F slightly smaller than the printing medium M in front view, the printing medium M can be attached to the second surface FB so that a part of the printing medium M does not come into contact with the second surface FB.

By attaching the printing medium M to the second surface FB so that a part of the printing medium M does not come into contact with the second surface FB, when removing the printing medium M from the platen 4, an operator can remove the printing medium M from the platen 4 while holding the part that does not come into contact with the second surface FB, and convenience can be improved. For example, the operator can easily remove the printing medium M from the platen 4 by hooking the operator's fingers on two of the four corner portions of the rectangular printing medium M, which are each a part of the printing medium M that does not come into contact with the second surface FB.

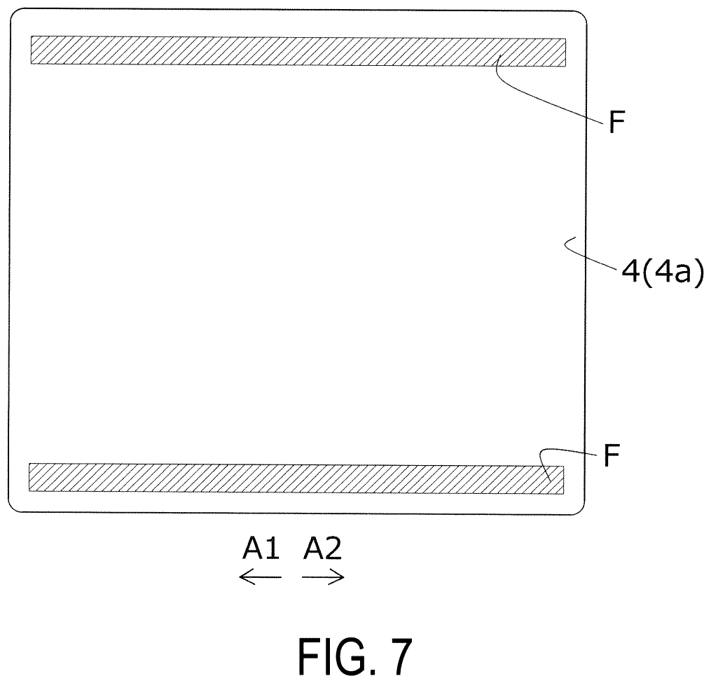

Further, as a configuration for attaching the printing medium M to the second surface FB so that a part of the printing medium M does not come into contact with the second surface FB, the double-sided adsorptive sheet F may be disposed only at a part of the placement surface 4a of the platen 4. In FIG. 7, the double-sided adsorptive sheets F are disposed at two positions along long sides of the placement surface 4a of the platen 4. With such a configuration, when removing the printing medium M from the platen 4, the operator can easily remove the printing medium M from the platen 4 while holding a part that does not come into contact with the second surface FB, and thus convenience can be improved.

The present disclosure is not limited to the above example, and various modifications are possible within the scope of the disclosure described in the claims, and these modifications are also included in the scope of the present disclosure. In addition, instead of using the double-sided adsorptive sheet F, it is also possible to use the printing apparatus 1 having a configuration in which an adsorptive layer is provided at the placement surface 4a of the platen 4.

What is claimed is:

1. A printing medium placement method, comprising:
a preparation step for attaching a first surface of a double-sided adsorptive sheet to a flat placement surface of a platen on which a sheet-like printing medium is placeable; and
a printing medium placement step for attaching the printing medium to a second surface opposite to the first surface of the double-sided adsorptive sheet attached in the preparation step, wherein
the double-sided adsorptive sheet includes an adsorptive layer at each of the first surface and the second surface, and adsorption force of the first surface for the placement surface is stronger than adsorption force of the second surface for the printing medium.

2. The printing medium placement method according to claim 1, wherein
the platen is mounted at a printing apparatus so as to reciprocate in a direction parallel to the placement surface, and
F2>m×a, where F2 is adsorption force of the second surface, m is a mass of the printing medium, and a is a maximum acceleration while the platen moves.

3. The printing medium placement method according to claim 2, wherein
F1>(m+ms)×a, where F1 is adsorption force of the first surface and ms is a mass of the double-sided adsorptive sheet.

4. The printing medium placement method according to claim 1, wherein
F1p>F2p, where F1p is a force required to peel off the first surface from the placement surface, and F2p is a force required to peel off the printing medium from the second surface, with respect to a direction intersecting the placement surface.

5. The printing medium placement method according to claim 1, wherein
the first surface has a self-adsorption property.

6. The printing medium placement method according to claim 1, wherein
the second surface has a self-adsorption property.

7. The printing medium placement method according to claim 1, wherein
in the printing medium placement step, the printing medium is attached to the second surface so that a part of the printing medium does not come into contact with the second surface.

8. The printing medium placement method according to claim 1, comprising a printing step for performing printing on the printing medium after the printing medium placement step is performed, wherein
the printing medium placement step is performed again with a pre-print printing medium for newly performing the printing step after a post-print printing medium is removed after the printing step is performed.

9. The printing medium placement method according to claim 1, wherein
the first surface and the second surface are formed to be distinguishable.

10. The printing medium placement method according to claim 9, wherein
at least one of the first surface and the second surface includes an identification mark.

11. A double-sided adsorptive sheet used in such a way that a first surface is attached to a flat placement surface of a platen on which a sheet-like printing medium is placeable and the printing medium is attached to a second surface opposite to the first surface, the double-sided adsorptive sheet comprising an adsorptive layer at each of the first surface and the second surface, wherein
adsorption force of the first surface for the placement surface is stronger than adsorption force of the second surface for the printing medium.
